(19) United States
(12) Patent Application Publication
(10) Pub. No.: US 2025/0378997 A1
(43) Pub. Date: Dec. 11, 2025

(54) MULTILAYER CERAMIC ELECTRONIC COMPONENT, ELECTROCONDUCTIVE MATERIAL, AND METHOD FOR PRODUCING MULTILAYER CERAMIC ELECTRONIC COMPONENT

(71) Applicant: Murata Manufacturing Co., Ltd., Nagaokakyo-shi (JP)

(72) Inventor: Toshihiko KOBAYASHI, Nagaokakyo-shi (JP)

(21) Appl. No.: 19/236,239

(22) Filed: Jun. 12, 2025

Related U.S. Application Data
(63) Continuation of application No. PCT/JP2023/043946, filed on Dec. 8, 2023.

(30) Foreign Application Priority Data
Dec. 20, 2022 (JP) 2022-202815

(51) Int. Cl. H01G 4/30; H01G 4/008; H01G 4/12; H01G 4/232

(52) U.S. Cl. CPC H01G 4/30; H01G 4/2325; H01G 4/0085; H01G 4/1209

(57) ABSTRACT

A multilayer ceramic electronic component includes outer electrodes including an electroconductive metal and glass including silicon. The electroconductive metal includes silver and copper, and a volume fraction of the copper is larger than a volume fraction of the silver. The silver and the copper are present in the form of silver particles, in the form of copper particles, and in the form of joined particles each including a silver particle and a copper particle joined together. The joined particles each have a flat shape. No copper is present on surfaces of the silver particles other than joint surfaces between the silver particles in the joined particles and the copper particles in the joined particles, and no silver is present on the surfaces of the copper particles other than joint surfaces. A portion of the copper in the outer electrodes is diffused into the inner electrodes.

### CROSS REFERENCE TO RELATED APPLICATIONS

This application claims the benefit of priority to Japanese Patent Application No. 2022-202815 filed on Dec. 20, 2022 and is a Continuation Application of PCT Application No. PCT/JP2023/043946 filed on Dec. 8, 2023. The entire contents of each application are hereby incorporated herein by reference.

### BACKGROUND OF THE INVENTION

### 1. Field of the Invention

The present invention relates to multilayer ceramic electronic components, electroconductive materials, and multilayer ceramic electronic component production methods and particularly to structures of outer electrodes on surfaces of ceramic bodies included in multilayer ceramic electronic components, an electroconductive materials for forming the outer electrodes, and multilayer ceramic electronic component production methods performed using the electroconductive materials.

### 2. Description of the Related Art

For example, Japanese Patent No. 6056388 describes a multilayer ceramic capacitor production method, which is a technique of interest to the present invention. In the technique described in Japanese Patent No. 6056388, a solution of a metal oxide precursor, such as a sol-gel material or an MOD material, which becomes the metal oxide when subjected to heat treatment, is used in order to reduce the thickness of the outer electrodes. By using the metal oxide precursor solution, the amount applied to the ceramic body can be reduced, so that the thickness of the outer electrodes can be reduced.

When a metal oxide film is subjected to reducing heat treatment, the metal precipitates. The metal forms an underlying metal film for ensuring contact with inner electrodes. The underlying metal film is microscopically a film-like aggregate including a large number of metal particles adhering to each other. The diameter of the metal particles is about 0.1 to 1 μm, and therefore the thickness of the underlying metal film is 0.1 to 1.0 μm on any coated surface. The material of the metal particles is, for example, Cu, Ni, W, Mo, Nb, Ta, Ti, or Zr.

To form the underlying metal film, a solution prepared by mixing, for example, a CuO coating solution and an ITO coating solution in a ratio of 7:3 is used. This solution is heat-treated in air at 480° C. for 40 minutes to oxidize the metal compounds and then heat-treated in a reducing atmosphere at 450° C. for 40 minutes to reduce part of the metal oxides.

In the technique described in Japanese Patent No. 6056388, to prevent a plating solution from penetrating through the underlying metal film, a sealing metal film whose density is higher than that of the underlying metal film is formed. The material of the sealing metal film is, for example, Cu, Ni, W, Mo, Nb, Ta, Ti, or Zr. It is preferable that the sealing metal film is thicker than the underlying metal film. Therefore, the sealing metal film is formed using a sputtering method, a vapor deposition method, a CVD method, etc., because the film thickness can be easily controlled.

### SUMMARY OF THE INVENTION

In the technique described in Japanese Patent No. 6056388, it is inferred that, as a result of precipitation of reduced Cu, the underlying metal layer includes ITO and remaining CuO. Therefore, in the underlying metal layer, the spaces between the particles are large, and the density of the underlying metal layer is low. This may be the reason that the electroconductivity of the underlying metal layer is low and the sealing properties against a plating solution and water vapor are insufficient. The formation of the sealing metal film provided to ensure the sealing properties not only prevents a reduction in the thickness of the outer electrodes but also leads to an increase in the number of production steps.

In the film having a thickness of 0.1 to 1.0 μm and obtained using the material and heat treatment described in Japanese Patent No. 6056388, the contact between the film and the inner electrodes including, for example, Ni as an electroconductive component may be insufficient.

Accordingly, example embodiments of the present invention provide multilayer ceramic electronic components in each of which, outer electrodes on a surface of a ceramic body have improved electroconductivity and in which good contact is established between the outer electrodes and inner electrodes inside the ceramic body. Example embodiments of the present invention also provide electroconductive materials for forming the outer electrodes and multilayer ceramic electronic component production methods performed using the electroconductive materials.

In example embodiments of the present invention, the structures of the outer electrodes in the multilayer ceramic electronic component are improved. Example embodiments of the present invention also provide electroconductive materials for forming the improved outer electrodes and multilayer ceramic electronic component production methods performed using the electroconductive materials.

A ceramic electronic component according to an example embodiment of the present invention includes a ceramic body including a plurality of laminated ceramic layers and an inner electrode extending along an interface between adjacent ones of the ceramic layers, and an outer electrode provided on a surface of the ceramic body and electrically connected to the inner electrode.

The outer electrode includes an electroconductive metal and glass including silicon, and the electroconductive metal includes silver and copper. A volume fraction of a silver component is larger than a volume fraction of a copper component, and the silver and the copper are present in a form of silver particles, in a form of copper particles, and in a form of joined particles each including a silver particle and a copper particle joined together. The joined particles each have a flat shape. No copper is present on surfaces of the silver particles other than joint surfaces between the silver particles in the joined particles and the copper particles in the joined particles, and no silver is present on surfaces of the copper particles other than the joint surfaces. A portion of the copper included in the outer electrode is diffused into the inner electrode.

An electroconductive material according to an example embodiment of the present invention includes an electroconductive metal salt that is in a sol state and that, when fired, becomes an electroconductive metal serving as an electroconductive component, a glass raw material that, when fired, becomes glass including silicon and that includes a metal salt for the glass, and a solvent to dissolve or disperse the electroconductive metal salt and the glass raw material. A ratio of a content of the glass raw material to a content of the electroconductive metal salt is about 0.04 or more and about 1.40 or less in terms of a ratio of a mass of the glass after conversion from the glass raw material to a mass of the metal after conversion from the electroconductive metal salt.

The electroconductive metal salt includes a silver salt and a copper salt, and a ratio of a volume of metallic silver after conversion from the silver salt to a volume of metallic copper after conversion from the copper salt is more than 1.

A multilayer ceramic electronic component production method according to an example embodiment of the present invention is a method for producing a multilayer ceramic electronic component including a ceramic body including a plurality of laminated ceramic layers and an inner electrode extending along an interface between adjacent ones of the ceramic layers, and an outer electrode provided on a surface of the ceramic body and electrically connected to the inner electrode, the method including applying the electroconductive material according to an example embodiment of the present invention to the surface of the ceramic body such that the electroconductive material comes into contact with the inner electrode, heat-drying the applied electroconductive material at a temperature of about 145° C. or higher, and firing the electroconductive material to form the outer electrode.

In a multilayer ceramic electronic component according to an example embodiment of the present invention, a portion of the copper in the outer electrode is diffused into the inner electrode, so good contact can be established between the outer electrode and the inner electrode. The silver in the outer electrode is not diffused into the inner electrode, and some of the silver particles are joined to the copper particles to form flat joined particles. In this state, the particles can easily come into contact with each other. Therefore, good electroconductivity can be obtained in the outer electrode, and good plating adhesion to the outer electrode can be obtained.

In an electroconductive material according to an example embodiment of the present invention, the volume fraction of the silver included is larger than the volume fraction of the copper included. Therefore, when the electroconductive material is fired, the flat joined particles including silver and copper particles joined together are easily generated. In this state, the particles can easily come into contact with each other, and good electroconductivity can be obtained in a conductive film such as an outer electrode that is formed using the electroconductive material. The electroconductive material is in a sol state. As gelation and vitrification proceed under heat treatment, the solvent and byproducts are removed. In this case, volume shrinkage in the thickness direction occurs in a conductive film such as an outer electrode that is formed using the electroconductive material, and this is advantageous in terms of a reduction in the thickness of the conductive film.

In a multilayer ceramic electronic component production method according to an example embodiment of the present invention, the above-described electroconductive material is heat-dried at a temperature of about 145° C. or higher, and therefore the silver particles can precipitate before firing, so that the silver particles are allowed to grow before the silver particles and the copper particles are joined together in the firing step. This is advantageous in terms of the growth of the flat joined particles and the formation of the outer electrode with a reduced thickness.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a cross-sectional view schematically illustrating a multilayer ceramic capacitor 1 that is a multilayer ceramic electronic component in an example embodiment of the present invention.

FIG. 2 is an enlarged cross-sectional view schematically illustrating a portion in which an outer electrode 6 of the multilayer ceramic capacitor 1 shown in FIG. 1 is provided.

FIG. 3 is an STEM image showing a cross section of an outer electrode of a multilayer ceramic capacitor in an Example produced in Experimental Examples.

FIG. 4 is an EDX image of the cross section of the outer electrode shown in FIG. 3.

FIG. 5 is an image obtained by highlighting Ag regions in the EDX image shown in FIG. 4.

FIG. 6 is an image obtained by highlighting Cu regions in the EDX image shown in FIG. 4.

FIG. 7 is an STEM image showing a cross section of an outer electrode of a multilayer ceramic capacitor in Comparative Example 1 produced in the Experimental Examples.

FIG. 8 is an EDX image of the cross section of the outer electrode shown in FIG. 7.

FIG. 9 is an image obtained by highlighting Ag regions in the EDX image shown in FIG. 8.

FIG. 10 is an image obtained by highlighting Cu regions in the EDX image shown in FIG. 8.

FIG. 11 is an STEM image showing a cross section of an outer electrode of a multilayer ceramic capacitor in Comparative Example 2 produced in the Experimental Examples.

FIG. 12 is an EDX image of the cross section of the outer electrode shown in FIG. 11.

### DETAILED DESCRIPTION OF THE EXAMPLE EMBODIMENTS

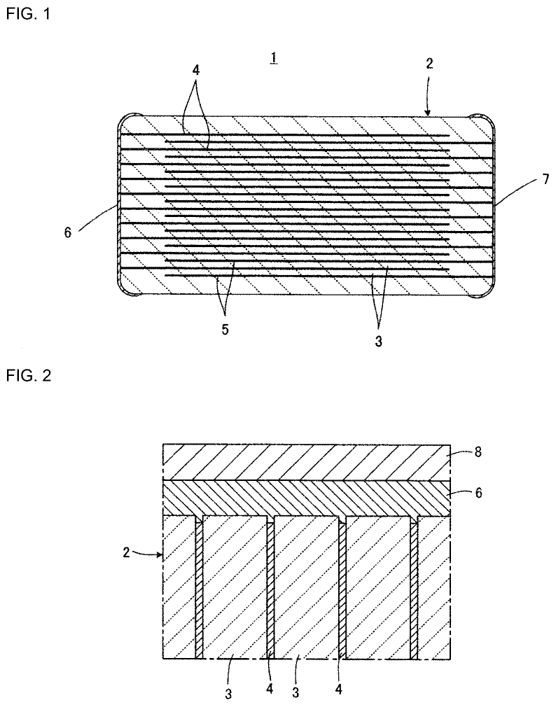

Referring to FIG. 1, the structure of a multilayer ceramic capacitor 1 that is a multilayer ceramic electronic component according to an example embodiment of the present invention will be described.

The multilayer ceramic capacitor 1 includes a ceramic body 2. The ceramic body 2 includes a plurality of laminated ceramic layers 3 and a plurality of inner electrodes 4 and 5 extending along interfaces between the plurality of ceramic layers 3. The inner electrodes 4 and 5 are classified into first inner electrodes 4 and second inner electrodes 5 that are alternately arranged in the laminating direction of the ceramic body 2. A first outer electrode 6 and a second outer electrode 7 are provided on the surface of the ceramic body 2, more specifically on its respective opposing end surfaces. The first outer electrode 6 is electrically connected to the first inner electrodes 4, and the second outer electrode 7 is electrically connected to the second inner electrodes 5.

The ceramic layers 3 include, for example, a dielectric ceramic including ABO₃ (wherein A is at least one of Ba, Ca, or Sr, and B is at least one of Ti or Zr) as a main component. The dielectric ceramic including ABO₃ as a main component may further include at least one of Mn, Mg, Si, Y, Dy, or Gd as a subcomponent.

The inner electrodes 4 and 5 include, as an electroconductive component, an electroconductive metal or an alloy including the electroconductive metal such as at least one of nickel, copper, silver, or a silver/palladium alloy and include particularly preferably nickel.

The outer electrodes 6 and 7 are formed by applying an electroconductive material described later to end surfaces of the ceramic body 2 such that the electroconductive material comes into contact with end portions of the inner electrodes 4 and 5 and then baking the applied electroconductive material. FIG. 2 is a cross-sectional view showing a portion of the first outer electrode 6. The second outer electrode 7 is not shown in FIG. 2 but has substantially the same structure as the first outer electrode 6. Therefore, only the first outer electrode 6 will be described, and the description of the second outer electrode 7 may be omitted. A plating film 8 (not shown in FIG. 1) is provided on the outer electrodes 6 and 7.

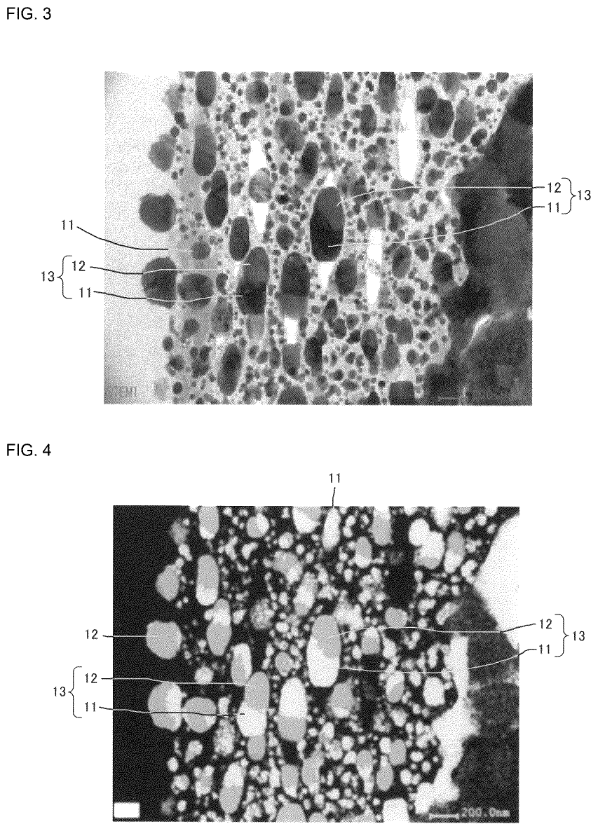

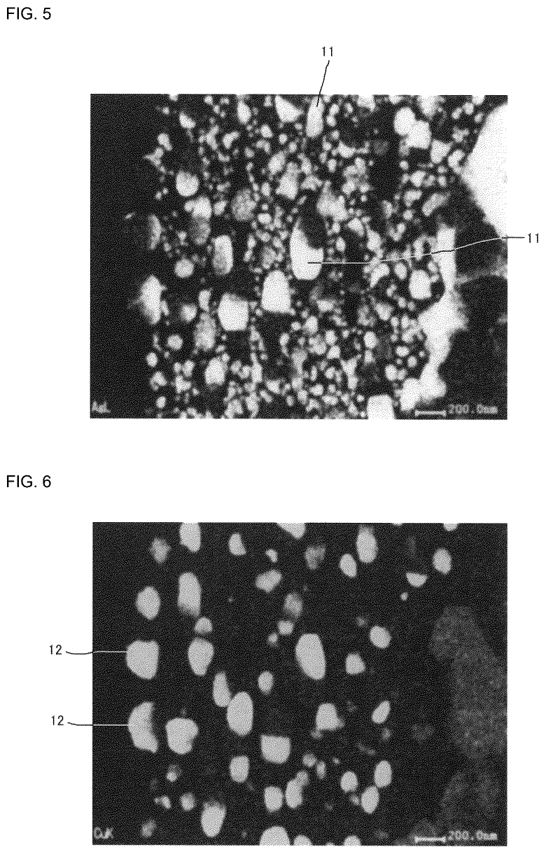

The outer electrodes 6 and 7 include an electroconductive metal and glass including silicon. The electroconductive metal includes silver and copper, and the volume fraction of the silver component is larger than the volume fraction of the copper component. The structure of the outer electrodes 6 and 7 will be described with reference to photographs showing a cross-section of an outer electrode of a multilayer ceramic capacitor produced in Experimental Examples described later. FIG. 3 shows an STEM image of the cross section of the outer electrode, and FIG. 4 shows an EDX image of the cross section of the outer electrode shown in FIG. 3. FIG. 5 shows an image obtained by highlighting Ag regions in the EDX image shown in FIG. 4, and FIG. 6 shows an image obtained by highlighting Cu regions in the EDX image shown in FIG. 4.

In particular, in FIG. 4, silver particles 11 appear as white granular regions, and copper particles 12 appear as gray granular regions. In FIG. 5, the regions in which the silver particles 11 are present are highlighted as whiter regions. In FIG. 6, the regions in which the copper particles 12 are present are highlighted as whiter regions.

Referring to FIGS. 3 to 6, in the outer electrodes, silver and copper are present in the form of silver particles 11, in the form of copper particles 12, and in the form of joined particles 13 each including a silver particle 11 and a copper particle 12 joined together. The joined particles 13 each have a flat shape. No copper is present on the surfaces of the silver particles 11 other than the joint surfaces between the silver particles 11 and the copper particles 12 in the joined particles 13, and no silver is present on the surfaces of the copper particles 12 other than the joint surfaces.

Although not shown in FIGS. 3 to 6, a portion of the copper included in the outer electrode 6 is diffused into the inner electrodes 4 as schematically illustrated in FIG. 2. Since a portion of the copper in the outer electrodes 6 and 7 has diffused into the inner electrodes 4 and 5 as described above, good contact can be obtained between the outer electrodes 6 and 7 and the inner electrodes 4 and 5.

The silver in the outer electrodes 6 and 7 is not diffused into the inner electrodes 4 and 5, but some of the silver particles 11 are joined to the copper particles 12 to form the flat joined particles 13 as described above. In this state, the particles can easily come into contact with each other. Therefore, good electroconductivity can be achieved in the outer electrodes 6 and 7, and good plating adhesion to the outer electrodes 6 and 7 can be achieved.

The multilayer ceramic capacitor 1 is produced, for example, through the following steps. First, a ceramic slurry including a ceramic raw material powder having the composition described above is produced. Next, an appropriate sheet forming method is used to form the ceramic slurry into ceramic green sheets. Next, an electroconductive paste that later becomes the inner electrodes 4 and 5 is applied by, for example, printing to prescribed ones of the plurality of ceramic green sheets. Next, the plurality of ceramic green sheets are laminated and then pressure-bonded to obtain a green ceramic body. Next, the green ceramic body is fired. Through the firing step, the ceramic green sheets become the ceramic layers 3. Then the step of forming the outer electrodes 6 and 7 on end surfaces of the ceramic body 2 is performed, and then the step of forming the plating film 8 on the outer electrodes 6 and 7 is performed.

The electroconductive material for forming the outer electrodes 6 and 7 includes a metal salt for the glass and an electroconductive metal salt that, when fired, becomes an electroconductive metal serving as an electroconductive component and further includes a glass raw material that, when fired, becomes the glass including silicon and a solvent to dissolve or disperse the electroconductive metal salt and the glass raw material. The ratio of the content of the glass raw material to the content of the electroconductive metal salt is about 0.04 or more and about 1.40 or less in terms of the ratio of the mass of the glass after conversion from the glass raw material to the mass of the metal after conversion from the electroconductive metal salt. The electroconductive metal salt includes a silver salt and a copper salt, and the ratio of the volume of metallic silver after conversion from the silver salt to the volume of metallic copper after conversion from the copper salt is more than 1.

The above electroconductive material is initially in a sol state. The electroconductive material in the sol state is applied to opposing end surfaces of the ceramic body 2 and then heat-dried, and the sol state is converted to a gel state as a result. The resulting electroconductive material is fired at a temperature higher than or equal to the softening point of the glass raw material and lower than or equal to its melting point, and the glass raw material is thereby vitrified.

In the heat-drying step, a temperature of about 145° C. or higher is applied, for example. This allows silver particles to precipitate before firing, and the silver particles are allowed to grow before the silver particles and the copper particles are joined together in the firing step. This is advantageous for the growth of the flat joined particles and the formation of the thin film-shaped outer electrodes.

Since a temperature of about 145° C. or higher is applied in the heat-drying step, it is preferable that the solvent included in the electroconductive material has a boiling point of about 145° C. or lower. For example, 2-methoxyethanol is advantageously used as the solvent.

In the electroconductive material, the volume fraction of the silver included is larger than the volume fraction of the copper included. Therefore, when the electroconductive material is fired, the flat the joined particles 13 each including a silver particle 11 and a copper particle 12 joined together are easily formed. In this state, the particles can easily come into contact with each other, and good electroconductivity can be obtained in the outer electrodes 6 and 7 formed using the electroconductive material. The electroconductive material is initially in a sol state. As the gelation and vitrification proceed under heat treatment, the solvent and byproducts are removed. Therefore, in the outer electrodes 6 and 7 formed using the electroconductive material, volume shrinkage occurs in the thickness direction, and this is advantageous in terms of a reduction in thickness.

Preferably, the glass raw material included in the electroconductive material includes nano-silica and boric acid in addition to the metal salt for the glass.

The metal salt for the glass in the glass raw material includes, for example, lithium nitrate and sodium nitrate.

The silver salt included in the electroconductive material includes, for example, at least one of silver carboxylate and silver nitrate, and the copper salt includes, for example, at least one of copper carboxylate and copper nitrate.

The electroconductive material may include an organic binder in order to adjust viscosity etc. Hydroxypropyl cellulose, for example, is advantageously used as the organic binder.

Although the details of the plating film 8 formed on the outer electrodes 6 and 7 is not illustrated, the plating film 8 includes, for example, a Cu plating layer, a Ni plating layer thereon, and a Sn plating layer thereon.

Example embodiments of the present invention have been described in relation to the outer electrodes of the multilayer ceramic capacitor. However, example embodiments of the present invention are applicable to any multilayer ceramic electronic component other than the multilayer ceramic capacitor so long as it is a multilayer ceramic electronic component including a ceramic body with a laminated structure including a plurality of laminated ceramic layers and inner electrodes disposed along interfaces between the ceramic layers, and outer electrodes on a surface of the ceramic body and electrically connected to the inner electrodes.

Next, Experimental Examples performed to examine the advantageous effects of example embodiments present invention will be described.

### EXAMPLES

### Production of Electroconductive Material

An electroconductive material in a sol state including the following (1) to (8) was produced:

(1) Tetraethoxysilane: 2.23% by mass.

(2) Boric acid: 0.38% by mass.

(3) Lithium nitrate (melting point: 260° C.): 0.20% by mass.

(4) Sodium nitrate (melting point: 306° C.): 0.27% by mass.

(5) Silver nitrate: 7.60% by mass.

(6) Copper (II) nitrate trihydrate: 11.02% by mass.

(7) Hydroxypropyl cellulose (2.0 to 2.9 @20° C./2% aqueous solution): 11.60% by mass.

(8) 2-Methoxyethanol: 54.71% by mass.

(1) to (4) above are used as a glass raw material that becomes glass when fired, and (3) and (4) are metal salts for the glass. (5) is a silver salt that becomes silver when fired. (6) is a copper salt that becomes copper when fired. (7) is an organic binder. (8) is a solvent.

The composition of the electroconductive material in this Example is shown also in Table 1 described later.

### Application and Firing

End surfaces of ceramic bodies for multilayer ceramic capacitors (0.6 mm×0.3 mm×0.3 mm) including Ni inner electrodes were immersed in the electroconductive material in a sol state, and the electroconductive material was dried at 150° C. for 10 minutes to gelate the electroconductive material. Opposite end surfaces of the ceramic bodies were also immersed in the electroconductive material, and the electroconductive material was dried.

Next, hydrogen gas was introduced into N₂, and firing was performed therein at 700° C., which is higher than or equal to the softening point of the glass raw material and lower than or equal to its melting point. The outer electrodes were thereby formed.

### Analysis of Structure of Outer Electrode

Structural analysis was performed on an outer electrode of one of the multilayer ceramic capacitors used as a specimen at the center of a surface extending in the width and thickness directions using an STEM (scanning electron microscope “HD-2300A” manufactured by Hitachi High-Tech Corporation) and an EDX (an energy dispersive X-ray spectrometer “Genesis XM4” manufactured by EDAX). Then an STEM image shown in FIG. 3 and EDX images shown in FIGS. 4 to 6 were obtained. FIG. 5 is an image obtained by highlighting Ag regions in the EDX image shown in FIG. 4, and FIG. 6 is an image obtained by highlighting Cu regions in the EDX image shown in FIG. 4.

In FIGS. 3 to 6, reference numerals “11,” “12,” and “13” are given respectively to representative silver particles 11, representative copper particles 12, and representative joined particles 13 each including a silver particle 11 and a copper particle 12 joined together.

As shown in FIGS. 3 to 6, flat joined particles 13 each including a silver particle 11 and a copper particle 12 joined together were found. No copper was found to be present on the surfaces of the silver particles 11 other than the joint surfaces between the silver particles 11 and the copper particles 12 in the joined particles 13, and no silver was found to be present on the surfaces of the copper particles 12 other than the joint surfaces.

### Plating

The outer electrodes were electroplated sequentially with Cu, Ni, and Sn under the following conditions to form a plating film.

### Cu Plating Conditions

Type of plating bath: Cu pyrophosphate plating bath (pH =8.6).
Bath temperature: 55° C.
Current value: 10 A.
Plating time: 90 minutes.

### Ni Plating Conditions

Type of plating bath: Watts bath (pH=4.0).
Bath temperature: 60° C.
Current value: 6 A.
Plating time: 51 minutes.

### Sn Plating Conditions

Type of plating bath: Neutral plating bath (pH=6.0).
Bath temperature: 25° C.
Current value: 3 A.
Plating time: 66 minutes.

### Evaluation of Bonding Between Inner Electrodes and Outer Electrodes

The resulting multilayer ceramic capacitor specimens were dried at 150° C. for 1.5 hours and then left to stand for 24 hours, and then the electrostatic capacitance and dielectric loss tangent were measured.

Next, a voltage of 25 V was applied to each specimen for 5 seconds, and the specimen was dropped onto a stainless steel plate to discharge the specimen (0 Ω discharge). This procedure was repeated 5 times.

The resulting specimen was dried at 150° C. for 1.5 hours and left to stand for 24 hours, and the electrostatic capacitance and the dielectric loss tangent were measured. The number of specimens was 20.

These results are shown in Table 1 described later.

### Comparative Example 1

### Production of Electroconductive Material

An electroconductive material in a sol state was produced using the same procedure as in the Example except that the ratios of silver nitrate and copper (II) nitrate trihydrate were changed as shown in Table 1.

### Application and Firing

The electroconductive material was applied, dried, and fired in the same manner as in the Example.

### Analysis of Structure of Outer Electrode

Structural analysis was performed on an outer electrode in the same manner as in the Example.

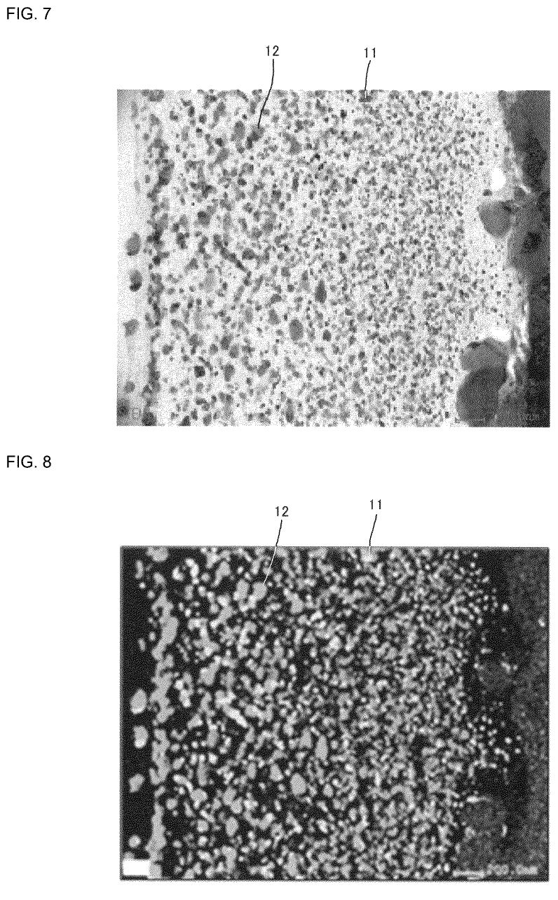

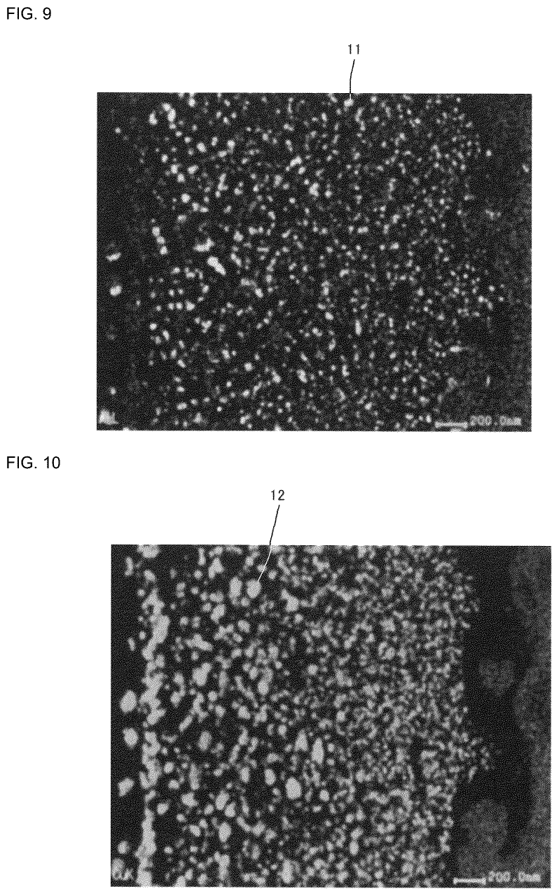

Then an STEM image shown in FIG. 7 and EDX images shown in FIGS. 8 to 10 were obtained. FIG. 9 is an image obtained by highlighting Ag regions in the EDX image shown in FIG. 8, and FIG. 10 is an image obtained by highlighting Cu regions in the EDX image shown in FIG. 8.

In FIGS. 7 to 10, reference numerals “11” and “12” are given respectively to representative silver particles 11 and representative copper particles 12.

As shown in FIGS. 7 to 10, in Comparative Example 1, the progress of the growth of the flat particles was less than that in the Example.

### Plating

Plating was performed in the same manner as in the Example.

### Evaluation of Bonding Between Inner Electrodes and Outer Electrodes

Evaluation was performed in the same manner as in the Example. The results are shown in Table 1 described later.

### Comparative Example 2

### Production of Electroconductive Material

An electroconductive material in a sol state was produced using the same procedure as in the Example except that no silver nitrate was included as shown in Table 1.

### Application and Firing

The electroconductive material was applied, dried, and fired in the same manner as in the Example.

### Analysis of Structure of Outer Electrode

Structural analysis was performed on an outer electrode in the same manner as in the Example.

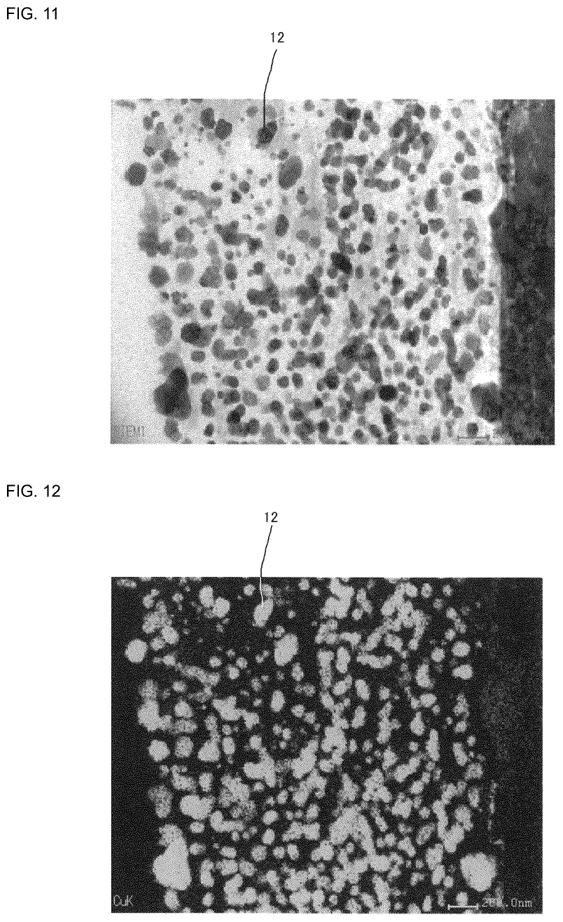

Then an STEM image shown in FIG. 11 and an EDX image shown in FIG. 12 were obtained. In FIGS. 11 and 12, reference numeral “12” is given to representative copper particles 12.

As shown in FIGS. 11 and 12, in Comparative Example 2, the progress of the growth of the flat particles was less than that in the Example.

### Plating

Plating was performed in the same manner as in the Example.

### Evaluation of Bonding Between Inner Electrodes and Outer Electrodes

Evaluation was performed in the same manner as in the Example. The results are shown in Table 1.

TABLE 1
(% by mass)

| | | Comparative | Comparative |
|---|---|---|---|
| | Example | Example 1 | Example 2 |
| Tetraethoxysilane | 2.23 | 2.23 | 2.47 |
| Boric acid | 0.38 | 0.38 | 0.43 |
| Lithium nitrate | 0.20 | 0.20 | 0.22 |
| Sodium nitrate | 0.27 | 0.27 | 0.30 |
| Copper(II) nitrate trihydrate | 11.02 | 16.69 | 18.49 |
| Silver nitrate | 7.60 | 2.28 | 0.00 |
| Hydroxypropyl cellulose | 11.60 | 11.60 | 11.60 |
| 2-Methoxyethanol | 54.71 | 54.37 | 54.38 |
| Coefficient of variation of | 1.2 (∘) | 1.3 (∘) | 1.1 (∘) |
| electrostatic capacitance before 0 | | | |
| Ω discharge | | | |
| Dielectric loss tangent before 0 Ω | 3.9 (∘) | 4.2 (∘) | 4.1 (∘) |
| discharge | | | |
| Coefficient of variation of dielectric | 1.1 (∘) | 1.8 (∘) | 2.2 (x) |
| loss tangent before 0 Ω discharge | | | |
| Coefficient of variation of | 1.3 (∘) | 1.2 (∘) | 1.1 (∘) |
| electrostatic capacitance after 0 Ω | | | |
| discharge | | | |
| Dielectric loss tangent after 0 Ω | 4.0 (∘) | 4.4 (Δ) | 4.1 (Δ) |
| discharge | | | |
| Coefficient of variation of dielectric | 0.9 (∘) | 6.5 (x) | 1.4 (∘) |
| loss tangent after 0 Ω discharge | | | |

In the Example, the values of the coefficients of variation of electrostatic capacitance before and after 0 Ω discharge, the dielectric loss tangents before and after 0 Ω discharge, and the coefficients of variation of dielectric loss tangent before and after 0 Ω discharge are smaller than those in Comparative Examples 1 and 2. This shows that, in the Example, good contact is established between the outer electrodes and the inner electrodes and that good electroconductivity is obtained in the outer electrodes. This may be because of the following reason. The electroconductive material in a sol state includes, dissolved therein, metal salts from which silver and copper will precipitate during heat treatment, and the volume of metallic silver after conversion from the silver salt is larger than the volume of metallic copper after conversion from the copper salt. In this case, copper diffuses sufficiently into the inner electrodes during firing, but silver does not diffuse. As shown in FIGS. 3 to 6, some of the silver particles 11 are joined to copper particles 12 to form flat joined particles 13. In the resulting state, the particles can easily come into contact with each other. Moreover, the presence of the flat joined particles 13 allows good plating adhesion to be achieved.

However, in Comparative Example 1, the values of the coefficients of variation of dielectric loss tangent before and after 0 Ω discharge and the dielectric loss tangent after 0 Ω discharge are larger than those in the Example. This may be because of the following reason. In the electroconductive material for forming the outer electrodes, the volume of metallic silver after conversion from the silver salt is smaller than the volume of metallic copper after conversion from the copper salt. Therefore, as shown in FIGS. 7 to 10, the growth of the flat joined particles including silver and copper particles joined together did not proceed easily, and the electroconductivity in the outer electrodes was insufficient.

In Comparative Example 2, the values of the coefficient of variation of dielectric loss tangent before 0 Ω discharge and the dielectric loss tangent after 0 Ω discharge are larger than those in the Example. This may be because of the following reason. The electroconductive material for forming the outer electrodes includes no silver salt. Therefore, as shown in FIGS. 11 and 12, flat particles did not grow, and the electroconductivity in the outer electrodes was insufficient

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A multilayer ceramic electronic component comprising:
a ceramic body including a plurality of laminated ceramic layers and an inner electrode extending along an interface between adjacent ones of the ceramic layers; and
an outer electrode provided on a surface of the ceramic body and electrically connected to the inner electrode; wherein the outer electrode includes an electroconductive metal and glass including silicon;
the electroconductive metal includes silver and copper;
a volume fraction of a silver component is larger than a volume fraction of a copper component;
the silver and the copper are present in a form of silver particles, in a form of copper particles, and in a form of joined particles each including a silver particle and a copper particle joined together;
the joined particles each have a flat shape;
no copper is present on surfaces of the silver particles other than joint surfaces between the silver particles in the joined particles and the copper particles in the joined particles;
no silver is present on surfaces of the copper particles other than the joint surfaces; and
a portion of the copper included in the outer electrode is diffused into the inner electrode.

2. The multilayer ceramic electronic component according to claim 1, wherein the inner electrode includes nickel as an electroconductive component.

3. The multilayer ceramic electronic component according to claim 1, wherein the multilayer ceramic electronic component is a multilayer ceramic capacitor.

4. The multilayer ceramic electronic component according to claim 1, wherein the ceramic layers include a dielectric ceramic including ABO₃, where A is at least one of Ba, Ca, or Sr, and B is at least one of Ti or Zr, as a main component.

5. The multilayer ceramic electronic component according to claim 1, wherein the ceramic layers include at least one of Mn, Mg, Si, Y, Dy, or Gd as a subcomponent.

6. The multilayer ceramic electronic component according to claim 1, wherein the inner electrode includes at least one of nickel, copper, silver, or a silver/palladium alloy.

7. An electroconductive material in a sol state comprising:
an electroconductive metal salt that, when fired, becomes an electroconductive metal serving as an electroconductive component;
a glass raw material that, when fired, becomes glass including silicon and that includes a metal salt for the glass; and
a solvent to dissolve or disperse the electroconductive metal salt and the glass raw material; wherein
a ratio of a content of the glass raw material to a content of the electroconductive metal salt is about 0.04 or more and about 1.40 or less in terms of a ratio of a mass of the glass after conversion from the glass raw material to a mass of the metal after conversion from the electroconductive metal salt;
the electroconductive metal salt includes a silver salt and a copper salt; and
a ratio of a volume of metallic silver after conversion from the silver salt to a volume of metallic copper after conversion from the copper salt is more than 1.

8. The electroconductive material according to claim 7, wherein the solvent has a boiling point of about 145° C. or lower.

9. The electroconductive material according to claim 8, wherein the solvent includes 2-methoxyethanol.

10. The electroconductive material according to claim 7, wherein the silver salt includes at least one of silver carboxylate or silver nitrate, and the copper salt includes at least one of copper carboxylate or copper nitrate.

11. The electroconductive material according to claim 7, further comprising an organic binder.

12. The electroconductive material according to claim 11, wherein the organic binder includes hydroxypropyl cellulose.

13. A method for producing a multilayer ceramic electronic component including a ceramic body including a plurality of laminated ceramic layers and an inner electrode extending along an interface between adjacent ones of the ceramic layers, and an outer electrode on a surface of the ceramic body and electrically connected to the inner electrode, the method comprising:
applying the electroconductive material according to claim 4 to the surface of the ceramic body such that the electroconductive material comes into contact with the inner electrode;
heat-drying the applied electroconductive material at a temperature of about 145° C. or higher; and
firing the electroconductive material to form the outer electrode.

14. The method for producing a multilayer ceramic electronic component according to claim 13, further comprising forming a plating film on the outer electrode.

15. The method for producing a multilayer ceramic electronic component according to claim 13, wherein the inner electrode includes nickel as an electroconductive component.

16. The method for producing a multilayer ceramic electronic component according to claim 13, wherein the multilayer ceramic electronic component is a multilayer ceramic capacitor.

17. The method for producing a multilayer ceramic electronic component according to claim 13, wherein the ceramic layers include a dielectric ceramic including ABO₃, where A is at least one of Ba, Ca, or Sr, and B is at least one of Ti or Zr, as a main component.

18. The method for producing a multilayer ceramic electronic component according to claim 13, wherein the ceramic layers include at least one of Mn, Mg, Si, Y, Dy, or Gd as a subcomponent.

19. The method for producing a multilayer ceramic electronic component according to claim 13, wherein the inner electrode includes at least one of nickel, copper, silver, or a silver/palladium alloy.
